(19) United States
(12) Patent Application Publication
(10) Pub. No.: US 2012/0059774 A1
(43) Pub. Date: Mar. 8, 2012

(54) ESTIMATE ASSISTING APPARATUS, METHOD FOR CONTROLLING THE SAME, AND RECORDING MEDIUM STORING A PROGRAM EXECUTED BY A COMPUTER

(75) Inventor: Daisuke MORITA, Kawasaki (JP)

(73) Assignee: FUJITSU LIMITED, Kawasaki (JP)

(21) Appl. No.: 13/222,073

(22) Filed: Aug. 31, 2011

(30) Foreign Application Priority Data
Sep. 6, 2010 (JP) 2010-199059

(51) Int. Cl. G06F 17/00

(52) U.S. Cl. 705/400

(57) ABSTRACT

An estimate assisting apparatus makes a temporary estimate upon receiving presented information regarding a certain service, issues an identification number corresponding to the presented information, obtains information regarding an alternative service corresponding to the certain service that is received by the temporary estimate, and generates an estimate request screen that includes information regarding the temporary estimate. A display control unit causes a display device to display the estimate request screen. An estimate providing unit makes an estimate and provides the estimate based upon information regarding a service selected on the estimate request screen and the presented information.

### CROSS-REFERENCE TO RELATED APPLICATIONS

This application is based upon and claims the benefit of priority of the prior Japanese Patent Application No. 2010-199059, filed on Sep. 6, 2010, the entire contents of which are incorporated herein by reference.

### FIELD

The embodiments relate to an estimate assisting apparatus, a method for controlling the estimate assisting apparatus, and a recording medium in which a program for controlling the estimate assisting apparatus is stored.

### BACKGROUND

People who are considering purchasing or requesting to repair products often call the call center of the manufacturer of the products first to consult about the purchase or the repair. Such clients who have called the call center receive an explanation of the purchase or the repair of the products, services, and the like from the call center. Some clients who have called the call center might decide to purchase or request to repair products during the same telephone call, but others might hang up without deciding whether or not to purchase or request to repair products.

If a client has decided to purchase or request to repair a product during the telephone call, the client can receive a service immediately on the basis of the content of an estimate made by the call center. On the other hand, a client who has not decided to purchase or request to repair a product keeps considering the purchase or the repair and then determines whether or not he/she receives a service on the basis of the content of an estimate provided through the telephone call. The client might call the call center at a later date and make a request for the service.

Even if the client have called the call center, it is possible that an operator at the call center cannot check the content of the estimate with which the client was provided previously from the call center. In that case, the client undesirably needs to ask the call center about a fee system and costs again.

Therefore, in order to save the trouble of asking the call center for an explanation, the client who has not decided to purchase or request to repair a product might make a request for a service on the Internet.

However, if the individual circumstances of the client have been taken into consideration during the communication with the call center, an estimate made on the basis of the communication might not be reflected on the Internet. In addition, the client might forget the content explained during the telephone call and therefore cannot judge the validity of an estimate when he/she sees the estimate that has been made again for the Internet.

A technique has been proposed in which results of communication with a client through a telephone call are accumulated and managed in a client information database and, if the client has made a telephone call again, an operator communicates with the client, referring to the client information database.

### SUMMARY

According to an aspect of the invention, an estimate assisting apparatus makes a temporary estimate upon receiving presented information regarding a certain service, issues an identification number corresponding to the presented information, obtains information regarding an alternative service corresponding to the certain service that is received by the temporary estimate, and generates an estimate request screen that includes information regarding the temporary estimate. A display control causes a display device to display the estimate request screen. An estimate provider makes an estimate and provides the estimate based upon information regarding a service selected on the estimate request screen and the presented information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of an estimate assisting apparatus according to a first embodiment.

FIG. 2 is a diagram of an example of the format of a request screen.

FIG. 3 is a diagram of an example of an authentication screen for displaying the request screen.

FIG. 4 is a diagram of an example of an operator screen and a presented information input screen.

FIG. 5 is a flowchart of an estimate assisting process executed by the estimate assisting apparatus according to the first embodiment.

FIG. 6 is a block diagram of an estimate assisting apparatus according to a second embodiment.

FIG. 7 is a block diagram of an estimate assisting apparatus according to a third embodiment.

FIG. 8 is a diagram illustrating a computer that executes a program for controlling an estimate assisting apparatus.

### DETAILED DESCRIPTION OF EMBODIMENT(S)

Embodiments of an estimate assisting apparatus, an estimate assisting system, a method for controlling the estimate assisting apparatus, a program for controlling the estimate assisting apparatus, and a recording medium in which the program for controlling the estimate assisting apparatus is stored disclosed herein will be described in detail hereinafter on the basis of the drawings. It is to be understood that the following embodiments do not limit the estimate assisting apparatus, the estimate assisting system, the method for controlling the estimate assisting apparatus, the program for controlling the estimate assisting apparatus, and the recording medium in which the program for controlling the estimate assisting apparatus is stored disclosed herein.

### First Embodiment

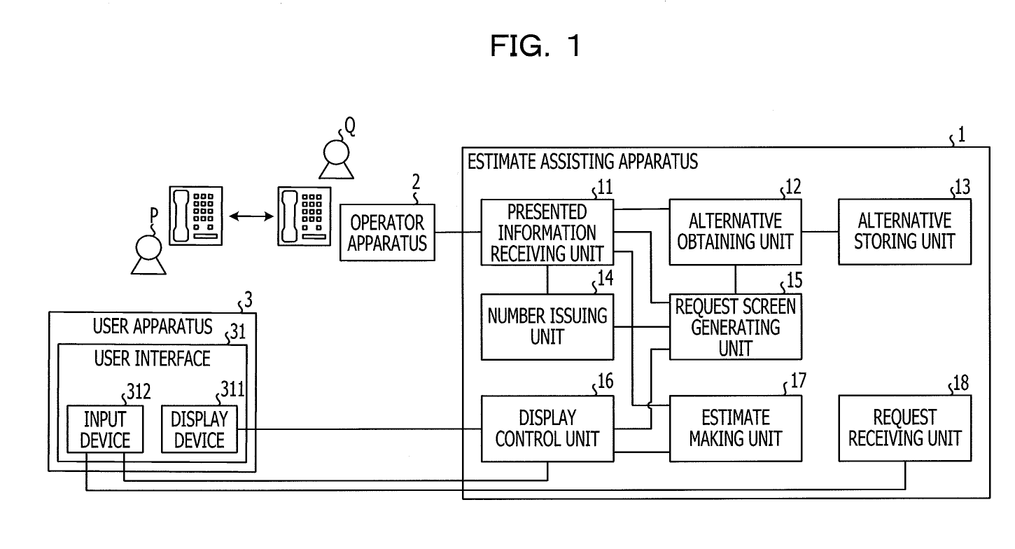

FIG. 1 is a block diagram of an estimate assisting apparatus according to a first embodiment. In this embodiment, an estimate assisting apparatus that assists in making an estimate of repair costs requested by a client will be described as an example.

As illustrated in FIG. 1, an estimate assisting apparatus 1 according to this embodiment is connected to an operator apparatus 2 and a user apparatus 3 through a network.

The estimate assisting apparatus 1 has a presented information receiving unit 11, an alternative obtaining unit 12, an alternative storing unit 13, a number issuing unit 14, a request screen generating unit 15, a display control unit 16, an estimate making unit 17, and a request receiving unit 18.

The presented information receiving unit 11 receives a request to display an input screen of presented information (hereinafter referred to as a “presented information input screen”) from the operator apparatus 2. The presented information receiving unit 11 then outputs a notice that the request to display the presented information input screen has been received to the number issuing unit 14, which will be described later. Here, the notice that the request to display the presented information input screen has been received may be simply a signal for indicating that there has been the request. After that, the presented information receiving unit 11 receives an estimate number and a password issued by the number issuing unit 14.

The presented information receiving unit 11 adds the estimate number and the password to the presented information input screen. The presented information receiving unit 11 then causes the operator apparatus 2 to display the presented information input screen to which the estimate number and the password have been added. After that, the presented information receiving unit 11 receives presented information from the operator apparatus 2 through the presented information input screen. Here, the presented information is a content that an operator Q has presented to a client P during a telephone call. The presented information includes, for example, information regarding a faulty component, the model number of a product to be repaired, the name and the mail address of the client P, and the content of the inquiry. In addition, a telephone set used for a telephone call may be a Voice over Internet Protocol (VoIP) telephone.

After that, the presented information receiving unit 11 outputs information regarding a faulty component to the estimate making unit 17, which will be described later. The presented information receiving unit 11 then receives, from the estimate making unit 17, an estimate of repair costs for the faulty component presented during a telephone call. The presented information receiving unit 11 then causes the operator apparatus 2 to display the estimate received from the estimate making unit 17.

Upon receiving an instruction for determining presented information from the operator apparatus 2, the presented information receiving unit 11 outputs information regarding a component for repair to the alternative obtaining unit 12 from among the presented information that has been determined. Here, because the input format of the input from the operator apparatus 2 is predetermined, the presented information receiving unit 11 can identify the information regarding a component for repair on the basis of the position on the presented information input screen.

Furthermore, upon receiving the instruction for determining presented information from the operator apparatus 2, the presented information receiving unit 11 outputs the presented information that has been determined to the request screen generating unit 15.

The number issuing unit 14 receives, from the presented information receiving unit 11, the notice that the request to display the presented information input screen has been received. The number issuing unit 14 then generates an estimate number and a password corresponding to the presented information. Here, the estimate number and the password may be any numbers, so long as unique presented information can be identified therewith. In addition, the estimate number and the password may include letters and the like. The number issuing unit 14 outputs the estimate number and the password that have been generated to the presented information receiving unit 11. In addition, the number issuing unit 14 stores the estimate number and the password in such a way as to associate the estimate number and the password with each other. In addition, if a notice that presented information has been input includes the mail address of the client P, the number issuing unit 14 also stores the mail address of the client P in such a way as to associate the mail address of the client P with the password. Therefore, the number issuing unit 14 may perform authentication on a request to display a request screen using either a combination between the estimate number and the password or a combination between the mail address and the password. Although the number issuing unit 14 notifies the operator Q of the estimate number and the password through the presented information receiving unit 11 in this embodiment, other methods may be used. For example, the number issuing unit 14 may notify the operator apparatus 2 of the estimate number and the password.

The alternative storing unit 13 is a storage apparatus such as a memory or a hard disk. The alternative storing unit 13 stores information regarding alternative services corresponding to information regarding services input from the operator apparatus 2. Here, “services” refers to, for example, components to be provided for repair. For example, as alternatives to a compact disc read-only memory (CD-ROM), a digital versatile disc read-only memory (DVD-ROM), a Blu-ray Disc (registered trademark), and the like are stored. Although alternative services will be described while taking components for repair as an example in this embodiment, services may be of other types. For example, services may be conditions for maintenance or types of campaigns. Alternative services to components for repair may be simply referred to as “alternative components” hereinafter.

The alternative obtaining unit 12 receives information regarding a component for repair from the presented information receiving unit 11. The alternative obtaining unit 12 then obtains, from the alternative storage unit 13, information regarding an alternative component corresponding to the input information regarding a component for repair. After that, the alternative obtaining unit 12 outputs the obtained information regarding an alternative component to the request screen generating unit 15.

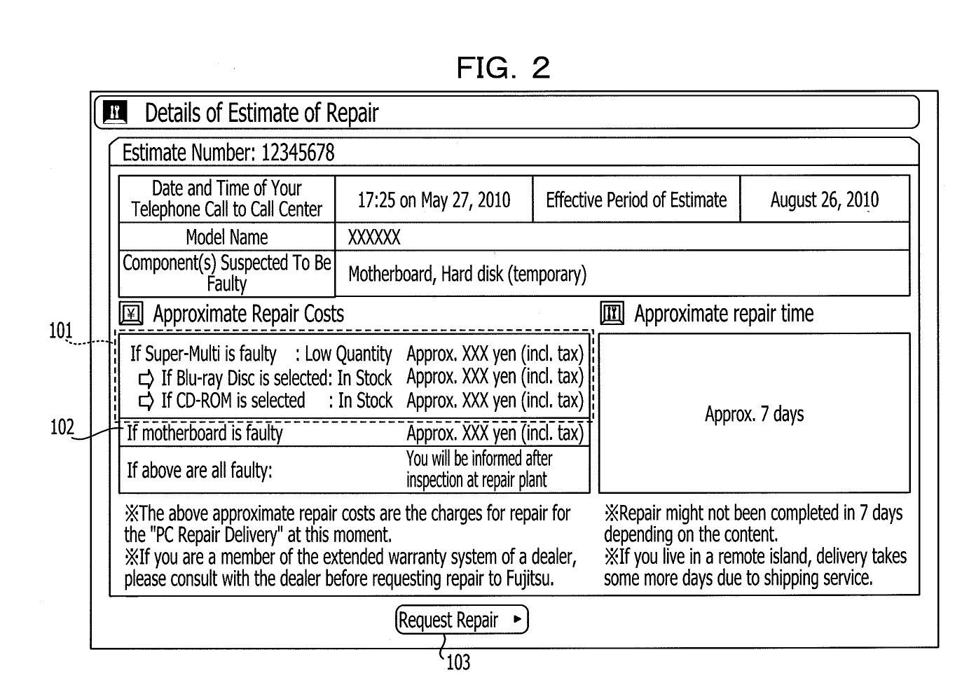

The request screen generating unit 15 stores a format of a request screen illustrated in FIG. 2 in advance. FIG. 2 is a diagram of an example of the format of the request screen. In the format of the request screen, as illustrated by a part encircled by a dotted line 101 in FIG. 2, a component for repair that has been presented during a telephone call and alternative components are displayed in such a way as to allow the client P to select any component. In addition, in the format of the request screen, if a component for repair has no alternative, only the component for repair that has been presented during a telephone call is displayed like an item 102. Furthermore, in the format of the request screen, items are provided in which an estimate number, the date and the time of a telephone call, the effective period of an estimate, the model number of a product to be repaired, a faulty portion, time taken for repair, and the like are written.

The request screen generating unit 15 receives, from the presented information receiving unit 11, presented information regarding services presented by the operator Q to the client P. In addition, the request screen generating unit 15 receives information regarding an alternative component from the alternative obtaining unit 12. In this embodiment, the request screen generating unit 15 receives the information regarding an alternative component from the alternative obtaining unit 12. Furthermore, the request screen generating unit 15 receives an estimate number from the number issuing unit 14.

The request screen generating unit 15 generates the request screen using an input estimate number, presented information, and information regarding an alternative component in the format of the request screen. The request screen generating unit 15 can then output the generated request screen to the display control unit 16. The request screen generating unit 15 stores the request screen in such a way as to associate the request screen with the estimate number.

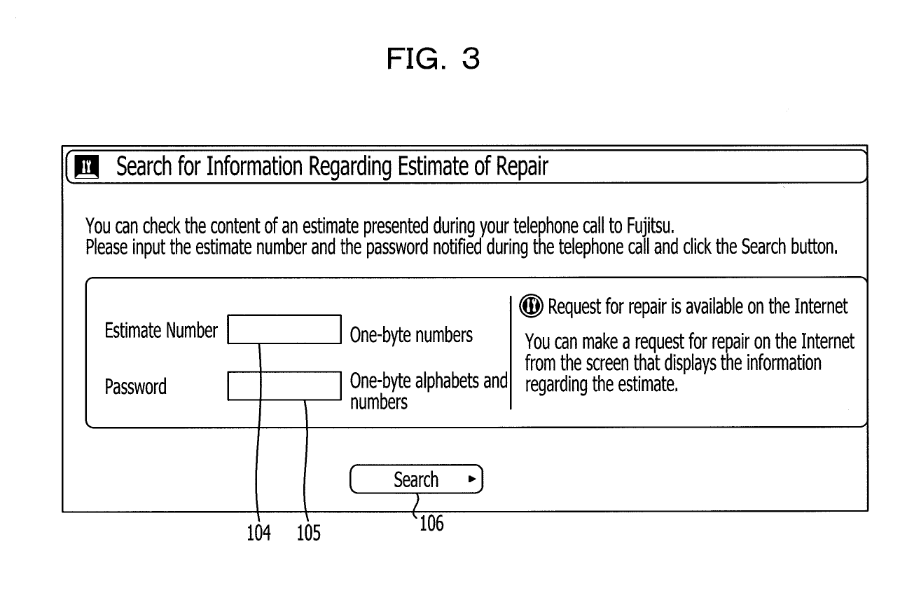

Upon receiving a request to display the request screen from an input device 312 of the user apparatus 3, the display control unit 16 causes a display device 311 of the user apparatus 3 to display an authentication screen for displaying the request screen illustrated in FIG. 3. FIG. 3 is a diagram of an example of the authentication screen for displaying the request screen. The display control unit 16 then receives a combination between an estimate number and a password from the input device 312 of the user apparatus 3. For example, the display control unit 16 receives data written in a field 104 as an estimate number and data written in a field 105 as a password.

The display control unit 16 searches the number issuing unit 14 to judge whether or not a combination between an estimate number and a password or a combination between a mail address and a password that has been input is stored. If a combination between an estimate number and a password or a combination between a mail address and a password that has been input is not stored, the display control unit 16 causes the display device 311 of the user apparatus 3 to display a massage that the request screen cannot be displayed.

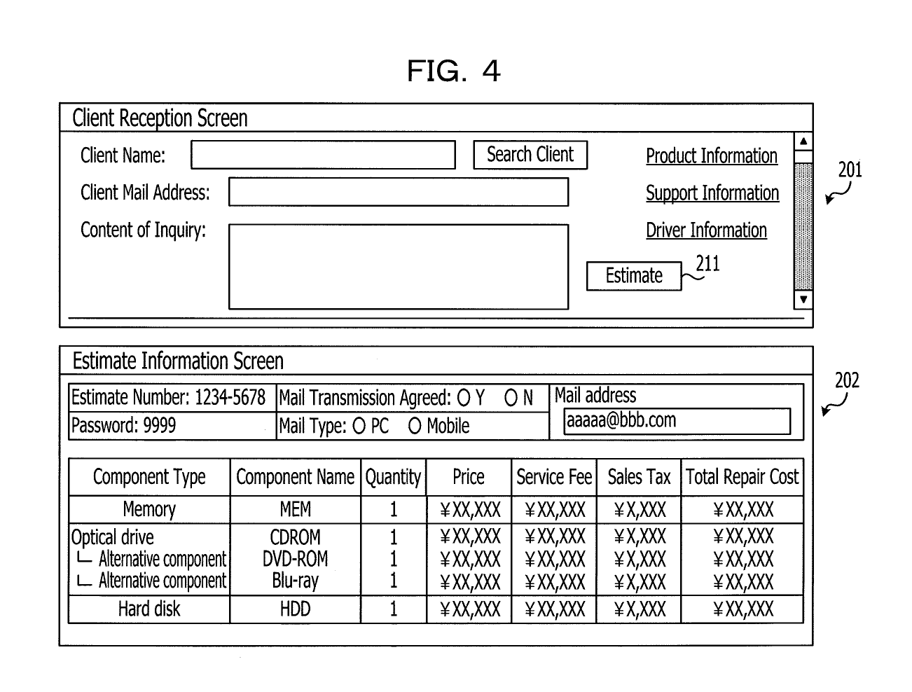

If a combination between an estimate number and a password or a combination between a mail address and a password that has been input is stored, the display control unit 16 searches the request screen generating unit 15 using the estimate number in order to obtain a request screen corresponding to the estimate number. The display control unit 16 then compares the time limit within which the estimate is effective that is described in the content of the obtained request screen and the current date. If the time limit has not been exceeded, the display control unit 16 causes the display device 311 of the user apparatus 3 to display the request screen, which according to an aspect of an embodiment can be similar to estimate information screen 202 in FIG. 4. If the time limit has been exceeded, the display control unit 16 causes the display device 311 of the user apparatus 3 to display a massage that the time limit has been exceeded.

When the client P has selected a component for repair or an alternative component on the request screen, the display control unit 16 receives information regarding the selection. The display control unit 16 then outputs information regarding a component selected by the client P and other components that need not be selected to the estimate making unit 17. After that, the display control unit 16 receives, from the estimate making unit 17, an estimate at a time when the component selected by the client P is used. The display control unit 16 then causes the display device 311 to display information regarding the new estimate input from the estimate making unit 17. If the client P has newly selected another component, the display control unit 16 outputs information regarding a newly selected component to the estimate making unit 17, and causes the display device 311 to display information regarding a new estimate input from the estimate making unit 17.

The estimate making unit 17 stores a table of the prices of components and a table of the repair costs of various repair operations. The estimate making unit 17 receives information regarding a component for repair and information regarding the content of repair from the presented information receiving unit 11. The estimate making unit 17 then obtains the price of an input component for repair and the repair costs corresponding to the content of repair from the tables stored therein. The estimate making unit 17 makes an estimate of repair on the basis of the price of the component for repair and the repair costs that have been obtained. After that, the estimate making unit 17 outputs the estimate to the presented information receiving unit 11. The presented information receiving unit 11 and the estimate making unit 17 are an example of a “temporary estimate making unit”.

Similarly, the estimate making unit 17 receives information regarding a component for repair and information regarding the content of repair from the display control unit 16. The estimate making unit 17 then obtains the price of an input component for repair and the repair costs corresponding to the content of repair from the tables stored therein. According to an aspect of an embodiment, the input component information via the display control unit 16 can be one or more of same information as obtained during initial intake by the operator (e.g., used for a re-estimate after a temporary estimate against same, new or updated price information) and/or subsequent new or changed input component information from the user that is used for a changed or amended estimate. The estimate making unit 17 makes an estimate of repair on the basis of the price of the component for repair and the repair costs that have been obtained. After that, the estimate making unit 17 outputs the estimate to the display control unit 16. The display control unit 16 and the estimate making unit 17 are an example of an “estimate providing unit”.

If the client P has determined to make a request for repair by, for example, pressing a request button, the request receiving unit 18 receives, from the input device 312 of the user apparatus 3, information regarding a component for repair selected on the request screen by the client P and information regarding an estimate. The request receiving unit 18 then stores the received information in a database for product repair. A department in charge of repairing products refers to this database for product repair to know what kind of repair work is to be performed.

The operator apparatus 2 is an apparatus operated by the operator Q who receives a telephone call from the client P. The operator Q receives a request for repair from the client P over the telephone. At this time, the operator Q asks the client P his/her name, his/her mail address, information regarding a faulty product, and the content of the failure over the telephone. The operator Q then identifies a faulty component and determines a component for repair and the content of repair on the basis of the information provided by the client P. After that, the operator Q explains the component for repair, the content of repair, and services for repair to the client P over the telephone. The operator Q then inputs, using the operator apparatus 2, presented information including the content explained to the client P during the telephone call to the estimate assisting apparatus 1.

For example, the operator apparatus 2 displays an operator screen 201 illustrated in FIG. 4. The operator screen 201 is a screen used by the operator Q during a telephone call, and allows the operator Q to easily access an activation button for the presented information input screen, information regarding products, support information, and the like. FIG. 4 is a diagram of an example of the operator screen 201 and the presented information input screen 202. The operator Q activates a presented information input screen 202 and causes the operator apparatus 2 to display the presented information input screen 202 by pressing an estimate button 211 on the operator screen 201. In this embodiment, the operator apparatus 2 writes an estimate number and a password input from the number issuing unit 14 on the presented information input screen 202 and displays the presented information input screen 202 for the operator Q. The operator Q inputs the mail address of the client P, a component for repair that has been presented, estimated costs, the content of the inquiry, and the like to the presented information input screen 202. The operator apparatus 2 outputs the information that has been input using the presented information input screen 202 to the presented information receiving unit 11.

As another embodiment, the operator Q may input client information and basic information of the inquiry such as the mail address of the client P and the content of the inquiry on the operator screen 201, and then may input information regarding an estimate such as the name of a component for repair that has been presented and estimated costs on the presented information input screen 202.

Furthermore, if the client P is a registered user, the operator Q may identify the client P on the operator screen 201, obtain the mail address of the client P from the registered information of the client P, and display the mail address of the client P on the presented information input screen 202.

Although the estimate assisting apparatus 1 makes an estimate on the basis of a faulty component and the content of a service, the operator Q may make an estimate instead. For example, the operator Q may make an estimate on the basis of a component for repair and the content of repair, and may input the estimate to the presented information input screen 202.

The operator apparatus 2 receives an estimate number and a password from the estimate assisting apparatus 1. The operator apparatus 2 then displays the estimate number and the password on a display device (not illustrated) thereof in order to notify the operator Q of the estimate number and the password. After being notified of the estimate number and the password from the operator apparatus 2, the operator Q notifies the client P of the estimate number and the password over the telephone.

The user apparatus 3 is an apparatus used by the client P. The user apparatus 3 has a user interface 31. The user interface 31 has the display device 311 and the input device 312. The client P uses the user interface 31 to input either a combination between an estimate number and a password or a combination between a mail address and a password. In this embodiment, a case in which the client P uses an estimate number and a password will be described.

For example, the client P uses the input device 312 to make a request to display the request screen to the estimate assisting apparatus 1. As a response to the request to display the request screen, the display device 311 receives a search screen for the request screen illustrated in FIG. 3 from the display control unit 16 of the estimate assisting apparatus 1. The display device 311 then displays the search screen for the request screen illustrated in FIG. 3. The client P refers to the search screen for the request screen displayed on the display device 311 in order to input an estimate number in the field 104 and a password in the field 105 using the input device 312. When the client P has pressed a button 106 using the input device 312, the user apparatus 3 outputs the estimate number and the password to the display control unit 16. As a response to the input of the estimate number and the password, the display device 311 receives the request screen from the display control unit 16. The display device 311 then displays the received request screen. The client P selects a component from among a component for repair that has been presented during the telephone call and alternative components, referring to the request screen displayed on the display device 311. Since the screen illustrated in FIG. 2 is displayed on the display device 311 in this embodiment, the client P selects a component to be used for repair from the part encircled by the dotted line 101 illustrated in FIG. 2 using the input device 312. Furthermore, the client P presses a request button 103 illustrated in FIG. 2 using the input device 312. By pressing the request button 103, a request for repair is made. The input device 312 inputs the request for repair to the request receiving unit 18 together with information regarding the component selected by the client P.

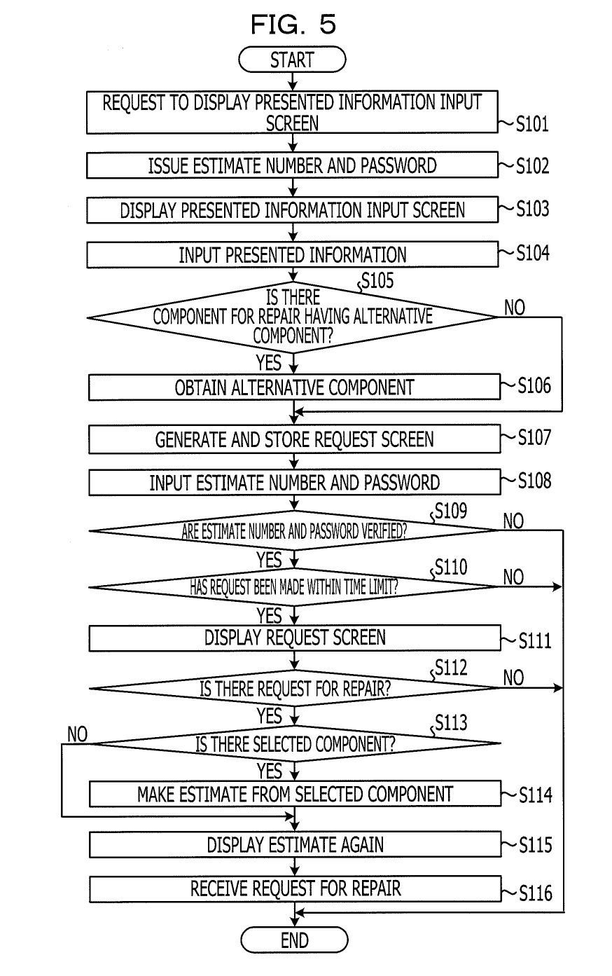

Next, the flow of an estimate assisting process in the estimate assisting apparatus according to the first embodiment will be described with reference to FIG. 5. FIG. 5 is a flowchart of the estimate assisting process in the estimate assisting apparatus according to the first embodiment.

The presented information receiving unit 11 receives a request to display a presented information input screen from the operator apparatus 2 operated by the operator Q (Operation S101). The presented information receiving unit 11 then outputs, to the number issuing unit 14, a notice that the request to display the presented information input screen has been received.

The number issuing unit 14 issues an estimate number and a password (Operation S102). The number issuing unit 14 then outputs the issued estimate number and the password to the presented information receiving unit 11.

After adding information regarding the estimate number and the password to the presented information input screen, the presented information receiving unit 11 causes the operator apparatus 2 to display the presented information input screen (Operation S103).

The operator Q inputs presented information determined during a telephone call with the client P to the presented information receiving unit 11 using the presented information input screen (Operation S104). The presented information receiving unit 11 receives, from the estimate making unit 17, an estimate made on the basis of a component for repair and the content of repair input from the operator apparatus 2. The presented information receiving unit 11 then displays the results of an estimate on the presented information input screen displayed on the operator apparatus 2.

When the operator Q has input the presented information, the presented information receiving unit 11 judges whether or not there is a component for repair, which has been presented by the operator Q, that has an alternative component (Operation S105).

If there is a component for repair that has an alternative component (YES in Operation S105), the presented information receiving unit 11 outputs, to the alternative obtaining unit 12, information regarding the component for repair that has an alternative component from among components for repair presented by the operator Q. The alternative obtaining unit 12 obtains, from the alternative storing unit 13, information regarding an alternative component corresponding to the component for repair presented by the operator Q (Operation S106). The alternative obtaining unit 12 then outputs the obtained information regarding an alternative component to the presented information receiving unit 11. On the other hand, if there is no component that has an alternative component (NO in Operation S105), the process proceeds to Operation S107.

The presented information receiving unit 11 outputs the presented information input from the operator apparatus 2 to the request screen generating unit 15. In addition, if there is information regarding an alternative component received from the alternative obtaining unit 12, the presented information receiving unit 11 also outputs the information regarding an alternative component to the request screen generating unit 15. The request screen generating unit 15 generates a request screen using the presented information and the information regarding an alternative component that have been received. The request screen generating unit 15 then stores the generated request screen (Operation S107).

Upon receiving a request to display the request screen from the user apparatus 3, the display control unit 16 causes the display device 311 of the user apparatus 3 to display the authentication screen. The display control unit 16 then receives an estimate number and a password from the user apparatus 3 through the authentication screen (Operation S108).

The display control unit 16 judges whether or not the estimate number and the password that have been input are verified through the authentication by checking whether or not the combination between the estimate number and the password that has been input matches a combination between an estimate number and a password that is stored in the number issuing unit 14 (Operation S109). If the estimate number and the password that have been input are not verified (NO in Operation S109), the estimate information providing apparatus 1 terminates the estimate assisting process.

On the other hand, if the estimate number and the password that have been input are verified (YES in Operation S109), the display control unit 16 obtains a request screen corresponding to the estimate number from the request screen generating unit 15 and then judges whether or not the request to display the request screen has been made within the time limit within which the estimate is effective (Operation S110). If the time limit has been exceeded (NO in Operation S110), the estimate assisting apparatus 1 terminates the estimate assisting process.

On the other hand, if the time limit has not been exceeded (YES in Operation S110), the display control unit 16 causes the display device 311 of the user apparatus 3 to display the request screen (Operation S111).

The display control unit 16 judges whether or not there is a request for repair from the user apparatus 3 (Operation S112). If there is no request for repair (NO in Operation S112), the estimate assisting apparatus 1 terminates the estimate assisting process.

On the other hand, if there is a request for repair (YES in Operation S112), the display control unit 16 judges whether or not there is a component selected by the client P in components for repair (Operation S113). If there is a component selected by the client P (YES in Operation S113), the estimate making unit 17 obtains the selected component, other components for repair, and the content of repair from the display control unit 16, and makes an estimate of repair (Operation S114). On the other hand, if there is no component that has been selected (NO in Operation S113), the process proceeds to Operation S115.

If there is a component selected by the client P, the display control unit 16 causes the display device 311 of the user apparatus 3 to display an estimate that has been newly made by the estimate making unit 17, and if there is no component that has been selected, the display control unit 16 causes the display device 311 of the user apparatus 3 to display the content of the estimate that has already been displayed again (Operations S115).

Upon receiving an instruction for determining a request for repair issued by the client P, the request receiving unit 18 receives the request for repair and stores the determined component for repair and the content of repair in a database (Operation S116).

As described above, the estimate assisting apparatus according to this embodiment adds an alternative to the content presented during a telephone call, displays the content and the alternative in such a way as to allow a user to select either the content or the alternative, and determines an estimate when the user has made a selection. Therefore, it is possible to easily check the content of an estimate presented during the telephone call and to easily make an estimate in accordance with the needs of the user, thereby reducing a load on the user when an estimate is made.

### Second Embodiment

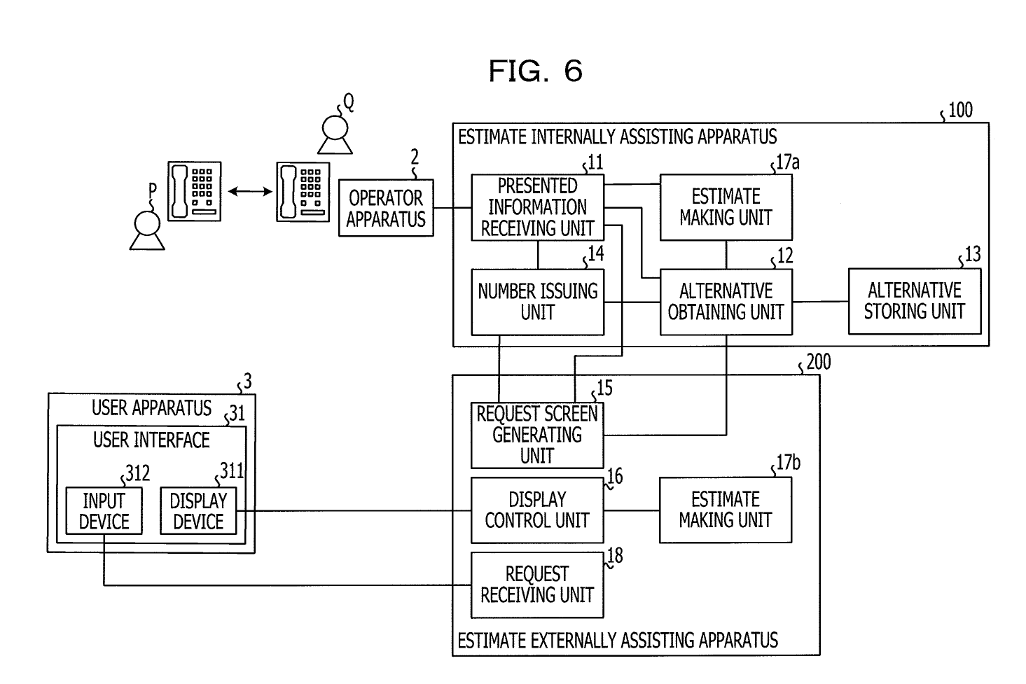

FIG. 6 is a block diagram of an estimate assisting system according to a second embodiment. The estimate assisting system according to this embodiment includes a plurality of apparatuses that collectively have the function of the estimate assisting apparatus according to the first embodiment. Here, components having the same reference numerals in FIGS. 1 and 6 have the same functions.

The estimate assisting system according to this embodiment has an estimate internally assisting apparatus 100 and an estimate externally assisting apparatus 200.

The estimate internally assisting apparatus 100 is an apparatus arranged in an in-house network of a company that provides services for repair. That is, the estimate internally assisting apparatus 100 cannot be accessed from outside the company.

The estimate internally assisting apparatus 100 has a presented information receiving unit 11, an alternative obtaining unit 12, an alternative storing unit 13, a number issuing unit 14, and an estimate making unit 17a.

The estimate making unit 17a has the same function as the estimate making unit 17 according to the first embodiment. However, the estimate making unit 17a receives information regarding a component for repair and information regarding the content of repair only from the presented information receiving unit 11. The estimate making unit 17a then makes an estimate and outputs the estimate to the presented information receiving unit 11.

The estimate externally assisting apparatus 200 is an apparatus arranged on the Internet. That is, the estimate externally assisting apparatus 200 may be accessed from outside the company that provides services for repair.

The estimate externally assisting apparatus 200 has a request screen generating unit 15, a display control unit 16, an estimate making unit 17b, and a request receiving unit 18.

The estimate making unit 17b has the same function as the estimate making unit 17 according to the first embodiment. However, the estimate making unit 17b receives information regarding a component for repair and information regarding the content of repair only from the display control unit 16. The estimate making unit 17b then makes an estimate and outputs the estimate to the display control unit 16.

Although the estimate internally assisting apparatus 100 and the estimate externally assisting apparatus 200 have the estimate making unit 17a and the estimate making unit 17b, respectively, in this embodiment, the estimate internally assisting apparatus 100 and the estimate externally assisting apparatus 200 may use only either the estimate making unit 17a or the estimate making unit 17b. Alternatively, an estimate making unit may be included in another apparatus (hereinafter referred to as an estimate making apparatus) and the estimate internally assisting apparatus 100 and the estimate externally assisting apparatus 200 may obtain an estimate made by the estimate making apparatus.

As described above, the estimate assisting system according to this embodiment includes an apparatus that receives a content presented during a telephone call and that makes an estimate and an apparatus that provides a client with a content presented during a telephone call, that receives a selection made by the client, and that makes an estimate. Therefore, if there is already an apparatus that receives a content presented during a telephone call and that makes an estimate, a system that allows the client to easily utilize the content presented during a telephone call can be created by simply adding the apparatus that provides the client with the content presented during a telephone call, that receives a selection made by the client, and that makes an estimate. In addition, a system capable of making an estimate in accordance with the needs of the client can be easily created.

### Third Embodiment

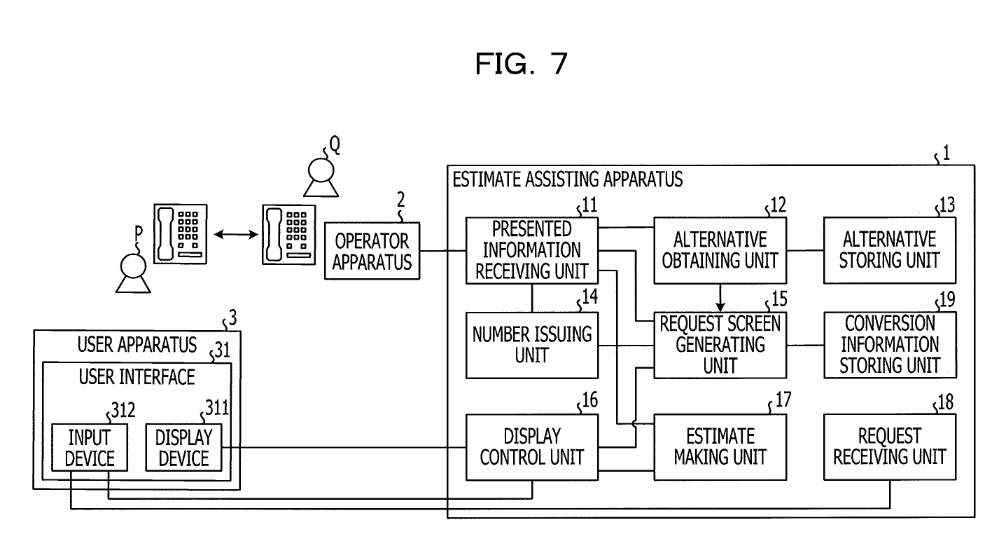

FIG. 7 is a block diagram of an estimate assisting system according to a third embodiment. The estimate assisting apparatus according to this embodiment is different from that according to the first embodiment in that presented information input by an operator is converted into a content that is suitable for display for a client before the presented information is displayed for the client. Therefore, in the following description, conversion of presented information will be mainly described. Here, components illustrated in FIGS. 1 and 7 having the same reference numerals have the same functions, unless otherwise described.

An estimate assisting apparatus 1 according to this embodiment is provided with a conversion information storing unit 19, which is not included in the estimate assisting apparatus 1 according to the first embodiment.

The conversion information storing unit 19 stores conversion information, which is a content to be displayed for the client P and corresponds to certain presented information.

Now, presented information and conversion information will be described in detail. The presented information is information input from the operator apparatus 2 by the operator Q. The operator Q often inputs presented information while talking with the client P over the telephone. Therefore, when inputting presented information, the operator Q might simplify the presented information by using abbreviations that only make sense inside his/her company. For example, a memory might be represented as a “MEM”. In this case, the client P could not understand the content of the presented information input by the operator Q as it is. Therefore, it is necessary to convert the presented information input by the operator Q into a content that can be understood by the client P. Information that includes the content that can be understood by the client P is the conversion information. In the case of the above-described example, the conversion information corresponding to the “MEM”, which is the presented information, is the “memory”.

The request screen generating unit 15 receives presented information from the presented information receiving unit 11. The request screen generating unit 15 then obtains, from the conversion information storing unit 19, conversion information corresponding to the presented information that has been input. In this embodiment, in order to quicken a search operation, the request screen generating unit 15 identifies a piece (portion or part) of presented information that needs a search for conversion information on the basis of the position on the presented information input screen to which presented information has been input, and obtains a piece of the conversion information corresponding to the piece of presented information from the conversion information storing unit 19. Alternatively, the request screen generating unit 15 may search the conversion information storing unit 19 for all pieces of the presented information, and use conversion information for pieces of the presented information for which corresponding pieces of the conversion information have been found.

The request screen generating unit 15 generates a request screen using presented information that has been received, obtained conversion information, and received information regarding an alternative component.

As described above, the estimate assisting apparatus 1 according to this embodiment converts the presented information input by the operator Q into a content that can be understood by the client P and displays the content. Therefore, even if the operator Q uses abbreviations in order to improve the efficiency at which the presented information is input, the client P can properly understand the content of an estimate.

Program

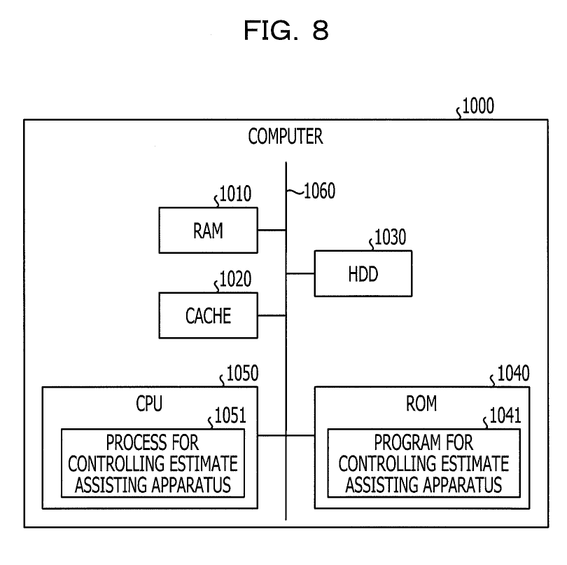

In addition, the various processes described in the above embodiments may be realized by executing a program prepared in advance on a computer. Therefore, an example of a computer that executes a program for controlling the estimate assisting apparatus, the program having a function of executing the estimate assisting process illustrated in FIG. 5, will be described hereinafter with reference to FIG. 8.

FIG. 8 is a diagram illustrating a computer that executes the program for controlling the estimate assisting apparatus. As illustrated in FIG. 8, a computer 1000 has a random-access memory (RAM) 1010, a cache 1020, a hard disk drive (HDD) 1030, a read-only memory (ROM) 1040, a central processing unit (CPU) 1050, and a bus 1060. The RAM 1010, the cache 1020, the HDD 1030, the ROM 1040, and the CPU 1050 are connected to one another by the bus 1060.

The ROM 1040 stores, in advance, a program 1041 for controlling the estimate assisting apparatus control that achieves a function of executing the estimate assisting process illustrated in FIG. 5.

The CPU 1050 reads and executes the program 1041 for controlling the estimate assisting apparatus. Thus, as illustrated in FIG. 8, the program 1041 for controlling the estimate assisting apparatus becomes a process 1051 for controlling the estimate assisting apparatus.

It is to be noted that the above-described program 1041 for controlling the estimate assisting apparatus need not necessarily be stored in the ROM 1040. For example, the program 1041 for controlling the estimate assisting apparatus may be stored in a “portable physical medium” that can be inserted into the computer 1000, such as a flexible disk (FD), a CD-ROM, a magneto-optical (MO) disk, a digital versatile disc (DVD), or an integrated circuit (IC) card. Alternatively, the program 1041 for controlling the estimate assisting apparatus may be stored in a “fixed physical medium” provided inside or outside the computer 1000, such as an HDD. Alternatively, the program 1041 for controlling the estimate assisting apparatus may be stored in “other computers (or servers)” connected to the computer 1000 through a public line, the Internet, a local area network (LAN), a wide area network (WAN), and the like. The computer 1000 may read the program 1041 for controlling the estimate assisting apparatus from the above-described FD or the like and execute the program 1041 for controlling the estimate assisting apparatus.

According to an aspect of the embodiments of the invention, any combinations of one or more of the described features, functions, operations, and/or benefits can be provided. A combination can be one or a plurality. The embodiments can be implemented as an apparatus (a machine) that includes hardware for performing the described features, functions, operations, and/or benefits, for example, hardware to execute instructions, for example, computing hardware (i.e., computing apparatus), such as (in a non-limiting example) any computer or computer processor that can store, retrieve, process and/or output data and/or communicate (network) with other computers. According to an aspect of an embodiment, the described features, functions, operations, and/or benefits can be implemented by and/or use computing hardware and/or software. As described with reference to FIG. 8, for example, the estimate assisting apparatuses 1 (100), estimate externally assisting apparatus 300, user apparatus 3, operator apparatus 2, can comprise a computing controller (CPU) (e.g., a hardware logic circuitry based computer processor that processes or executes instructions, namely software/program), computer readable media, transmission communication interface (network interface), and/or an output device, for example, a display device, and which can be in communication among each other through one or more data communication buses. In addition, an apparatus can include one or more apparatuses in computer network communication with each other or other devices. In addition, a computer processor can refer to one or more computer processors in one or more apparatuses or any combinations of one or more computer processors and/or apparatuses. An aspect of an embodiment relates to causing and/or configuring one or more apparatuses and/or computer processors to execute the described operations. The results produced can be output to an output device, for example, displayed on the display. An apparatus or device refers to a physical machine that performs operations, for example, a computer (physical computing hardware or machinery) that implement or execute instructions, for example, by way of software, which is code executed by computing hardware, and/or by way of computing hardware (e.g., in circuitry, etc.), to achieve the functions or operations being described. The functions of embodiments described can be implemented in any type of apparatus that can execute instructions or code. More particularly, programming or configuring or causing an apparatus or device, for example, a computer, to execute the described functions of embodiments of the invention creates a new machine where in case of a computer a general purpose computer in effect becomes a special purpose computer once it is programmed or configured or caused to perform particular functions of the embodiments of the invention pursuant to instructions from program software.

A program/software implementing the embodiments may be recorded on a computer-readable media, e.g., a non-transitory or persistent computer-readable medium. The program/software implementing the embodiments may be transmitted over a transmission communication path, e.g., a wire and/or a wireless network implemented via hardware. An example of communication media via which the program/software may be sent includes, for example, a carrier-wave signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. An estimate assisting apparatus comprising:
an alternative storing unit that stores information regarding an alternative service corresponding to a certain service;
a temporary estimate making unit that makes a temporary estimate upon receiving presented information that is determined through a telephone call from a client and that includes information regarding the certain service;
a number issuing unit that issues an identification number and a password corresponding to the presented information;
an alternative obtaining unit that refers to the alternative storing unit to obtain the information regarding the alternative service corresponding to the certain service that is received by the temporary estimate making unit;
a request screen generating unit that causes display of an estimate request screen corresponding to the identification number and password, that includes information regarding the temporary estimate, that supports subsequent selection of one or more of the certain service or the alternative service, and that generates an estimate request screen corresponding to the subsequent selection and the presented information;
an estimate providing unit that makes an estimate and provides the estimate on the basis of information regarding a service selected on the estimate request screen and the presented information; and
a request receiving unit that receives a request for a service based on the estimate provided by the estimate providing unit.

2. The estimate assisting apparatus according to claim 1, wherein the certain service includes information regarding a component for repair.

3. The estimate assisting apparatus according to claim 1, further comprising:
a conversion information storing unit that stores pieces of the presented information and pieces of information for displaying the pieces of the presented information in such a way as to associate the pieces of the presented information with the pieces of information for displaying the pieces of the presented information,
wherein the request screen generating unit obtains a piece of information for displaying a piece of the presented information from the conversion information storing unit, and generates the estimate request screen in such a way that a content of a piece of the presented information is displayed using the obtained piece of information for displaying the piece of the presented information.

4. The estimate assisting apparatus according to claim 1,
wherein the presented information includes a mail address, and
wherein, upon receiving the mail address and a password, the display control unit causes the display device to display a request screen corresponding to a combination between the mail address and the password.

5. A method of providing an estimate for a certain service, the method comprising:
using one or more computing apparatuses to execute:
making a temporary estimate upon receiving presented information that is determined through a telephone call from a client and that includes information regarding the certain service;
issuing an identification number and a password corresponding to the presented information;
obtaining information regarding an alternative service corresponding to the certain service that is received based upon information regarding the alternative service corresponding to the certain service;
displaying an estimate request screen corresponding to the identification number and password, and that includes information regarding the temporary estimate, and supports subsequent selection of one or more of the certain service or the alternative service;
generating an estimate request screen corresponding to the subsequent selection and the presented information;
making an estimate and providing the estimate based upon information regarding a service selected on the estimate request screen and the presented information; and
processing a request for a service based on the provided estimate.

6. A non-transitory computer-readable recording medium storing a program executed by a computer, the program causing the computer to execute a method, the method comprising:
making a temporary estimate upon receiving presented information that is determined through a telephone call from a client and that includes information regarding a certain service;
issuing an identification number and a password corresponding to the presented information;
obtaining information regarding an alternative service corresponding to the certain service that is received based upon information regarding the alternative service corresponding to the certain service;
displaying an estimate request screen corresponding to the identification number and password, and that includes information regarding the temporary estimate, and supports subsequent selection of one or more of the certain service or the alternative service;
generating an estimate request screen corresponding to the subsequent selection and the presented information;
making an estimate and providing the estimate based upon information regarding a service selected on the estimate request screen and the presented information; and
processing a request for a service based on the provided estimate.
